(19) United States
(12) Patent Application Publication
(10) Pub. No.: US 2026/0220021 A1
(43) Pub. Date: Jul. 30, 2026

(54) IN-DEPTH CODE ANALYZER

(71) Applicant: Bank of America Corporation, Charlotte, NC (US)

(72) Inventors: Chaithanya Chimmula, Plano, TX (US); Dhuvaraga Prasath B, Tamil Nadu (IN); Imran Khan, Haryana (IN); Vinod Maghnani, Haryana (IN); Sivashobika Sivasamy, Tamil Nadu (IN); Madhumitha Swaminathan Rangarajan, Tamil Nadu (IN)

(21) Appl. No.: 19/037,919

(22) Filed: Jan. 27, 2025

(51) Int. Cl. G06F 11/3604

(52) U.S. Cl. CPC G06F 11/3608

(57) ABSTRACT

Apparatus and methods for an in-depth code analyzer are provided. The in-depth code analyzer may utilize multi-modal artificial intelligence/machine learning to analyze code. An in-depth code analyzer may receive two or more quanta of data, including source code, for a software application. The code analyzer may preprocess the data. The code analyzer may analyze the data. The code analyzer may calculate two or more metrics of the software application. The code analyzer may use the two or more metrics to create a strategic upgrade plan. The code analyzer may implement the strategic upgrade plan. The code analyzer may monitor performance of the software application before and after implementation of the strategic upgrade plan.

### FIELD OF TECHNOLOGY

Aspects of the disclosure relate to providing apparatus and methods to automatically analyze software code in-depth and automatically provide upgrade tasks and suggestions.

### BACKGROUND OF THE DISCLOSURE

Entities may include individuals, corporations, partnerships, non-profits, government agencies or branches, and other groups of people. Entities may be any size, including small (one member or employee) or large (thousands of employees or members). Entities may have an internal network. Entities may have one or more units of computer equipment, including servers, personal computers, and mobile computing devices.

Currently, an entity may have two or more instances of a service/application across a network. These instances may be on multiple servers. These instances may be on a local hard drive or in the cloud. Often, the instances may be of multiple different versions of the same software, as not all instances may be updated at the same time. This may especially be true for a local instance of a program that is downloaded to a particular workstation and runs locally.

In addition, a larger entity may create or have developed unique and bespoke software programs or portion of programs for the entity's particular needs. These unique and bespoke programs may have less documentation and support than widely available software programs.

Further, entities generally have multiple different applications running concurrently on various computer systems across a network. Each separate application, and each version of each application may interact with other applications in unique ways.

In product development, data often flows through multiple applications, each built using different technologies tailored to the specific data they process. Updating or migrating each application to a new version or new application may affect data processing or other applications, as well as be difficult because of the original bespoke code.

Further, there may be significant challenges due to code complexity from two primary sources: Legacy code logic: The application may contain outdated code structures that were developed under different technological paradigms, making them difficult to maintain and update; and Automated Tool Migration: Code migrated from one tool to another may not be optimized for the new tool's features, resulting in convoluted code that mirrors the original structure rather than leveraging the new tool's capabilities.

These issues may affect multiple applications within a particular computing system. As a result, apparatus and methods are needed to interact with and traverse through these complex applications to achieve the outcome of efficient and effective code updating and migration.

Currently, creating an efficient and standardized workflow to update and migrate services with different versions and in different locations may be a time-consuming and resource intensive task. In addition, migrating from one version of software to another (e.g., from a desktop version to a cloud version or from version 1.1 to version 1.2) may also lead to security and network issues and policy violations while trying to replicate the legacy version into the cloud, or updating other versions. Many projects may only include initial design documentation which has less impact in connecting with the target state migration and its supporting functionalities and third-party dependencies.

One step of efficient and effective code updating and code migration may be analyzing the original code in depth to determine the complexity of the code and what needs to be updated, changed, or modified.

Multi-modal artificial intelligence/machine learning (“AI/ML”) algorithms may refer to AI/ML algorithms that can process and combine multiple types of input data to perform one or more tasks. The input data may be text, images, video, audiovisual, audio, or other types of data.

Currently, there is no apparatus or method available to automatically analyze code with multi-modal AI/ML to prioritize issues related to code updating or migration.

Therefore, it would be desirable for apparatus and methods for an in-depth code analyzer utilizing multi-modal AI/ML algorithms.

### SUMMARY OF THE DISCLOSURE

It is an object of this disclosure to provide apparatus and methods for an in-depth code analyzer utilizing multi-modal AI/ML algorithms.

An in-depth code analyzer computer program product is provided. The computer program product may include executable instructions stored on non-transitory memory of a computer system.

When the executable instructions are executed by a processor on the computer system they may gather or receive two or more quanta of data from the computer system or a second computer system.

The data may include source code for one or more applications installed on the computer system or the second computer system. The data may include documentation for the one or more applications. The data may include one or more logs for one or more uses of the one or more applications. The data may include one or more configuration files for the one or more applications. The data may include one or more user inputs. The data may include one or more issue reports. The data may include other data.

The instructions may store the two or more quanta of data in a database. The database may be part of the computer system or separate from the computer system.

The instructions may pre-process the two or more quanta of data.

The instructions may store the pre-processed two or more quanta of data in the database or a different database.

The instructions may analyze, with one or more multi-modal artificial intelligence/machine learning algorithms, the processed two or more quanta of data.

The instructions may calculate two or more metrics based on the analysis.

The instructions may automatically design and prioritize a strategic upgrade plan based on the two or more calculated metrics.

The instructions may automatically implement the strategic upgrade plan.

The instructions may initiate an automatic performance monitoring system. The automatic performance monitoring system may monitor performance of the one or more applications before and after the strategic upgrade plan is implemented.

In an embodiment, the computer system may be on a network. The network may be the Internet. The network may be an internal intranet.

In an embodiment, the executable instructions may further search the network for one or more additional computer systems where the one or more applications are installed on the one or more additional computer systems.

In an embodiment, when the one or more additional computer systems are discovered, the instructions may install a copy of the in-depth code analyzer computer program product on each additional computer system, creating an original code analyzer and one or more copied code analyzers.

In an embodiment, when the instructions install the one or more copied code analyzers, each copy may record two or more quanta of data in the database.

In an embodiment, the original code analyzer may analyze all data in the database.

In an embodiment, the calculated two or more metrics may include one or more of: a code complexity score; a dependency risk score; a performance impact score; an error proneness score; a documentation quality score; a user feedback priority score; and other metrics.

In an embodiment, the strategic upgrade plan may include one or more of: a prioritization of one or more software modules to upgrade; a resource allocation plan; documentation enhancement; addressing one or more needs of a user; managing one or more elements of risk; and other plans.

In an embodiment, the prioritization of one or more software modules to upgrade may utilize the code complexity score and the error proneness score, as well as other metrics.

In an embodiment, the resource allocation plan may utilize the dependency risk score, as well as other metrics.

In an embodiment, the documentation enhancement may utilize the documentation score, as well as other metrics.

In an embodiment, addressing one or more needs of a user may utilize the user feedback priority score as well as other metrics.

In an embodiment, managing risk may utilize the error proneness score and the dependency risk score, as well as other metrics.

In an embodiment, the instructions may implement the strategic upgrade plan using machine-readable code.

### BRIEF DESCRIPTION OF THE DRAWINGS

The objects and advantages of the disclosure will be apparent upon consideration of the following detailed description, taken in conjunction with the accompanying drawings, in which like reference characters refer to like parts throughout, and in which:

FIG. 1 shows an illustrative apparatus in accordance with principles of the disclosure.

FIG. 2 shows an illustrative apparatus in accordance with principles of the disclosure.

FIG. 3 shows an illustrative schematic in accordance with principles of the disclosure.

FIG. 4 shows an illustrative schematic in accordance with principles of the disclosure.

FIG. 5 shows an illustrative flowchart in accordance with principles of the disclosure.

FIG. 6 shows an illustrative apparatus in accordance with principles of the disclosure.

### DETAILED DESCRIPTION OF THE DISCLOSURE

It is an object of this disclosure to provide apparatus and methods for an in-depth software code analyzer program.

An in-depth code analyzer computer program product is provided. The computer program product may include executable instructions stored on non-transitory memory of a computer system.

Multiple processors may increase the speed and capability of the program. The executable instructions may be stored in non-transitory memory on the computer system or a remote computer system, such as a server.

Other standard components of a computer system may be present. The computer system may be a server, mobile device, or other type of computer system. A server or more powerful computer may increase the speed at which the computer program may run. Portable computing devices, such as a smartphone, laptop or tablet, may increase the portability and usability of the computer program, but may not be as secure or as powerful as a server or desktop computer.

The term “non-transitory memory,” as used in this disclosure, is a limitation of the medium itself, i.e., it is a tangible medium and not a signal, as opposed to a limitation on data storage types (e.g., RAM vs. ROM). “Non-transitory memory” may include both RAM and ROM, as well as other types of memory.

The computer may include, among other components, a communication link, a processor or processors, and a non-transitory memory configured to store executable data configured to run on the processor. The executable data may include an operating system and the in-depth code analyzer computer program.

A processor or processors may control the operation of the computer system and its components, which may include RAM, ROM, an input/output module, and other memory. The microprocessor(s) may also execute all software running on the apparatus and computer system. Other components commonly used for computers, such as EEPROM or Flash memory or any other suitable components, may also be part of the apparatus and computer system.

A communication link may enable communication with other computers as well as any server or servers. The communication link may include any necessary hardware (e.g., antennae) and software to control the link. Any appropriate communication link may be used, such as Wi-Fi, bluetooth, LAN, and cellular links. In an embodiment, the network used may be the Internet. In another embodiment, the network may be an internal intranet or other network.

The computer system may be a server. The computer program may be run on a powerful smart mobile device. The computer program, or portions of the computer program may be linked to other computers or servers running the computer program. The server or servers may be centralized or distributed. Centralized servers may be more powerful and secure than distributed servers but may also be more expensive and less resilient.

When the executable instructions are executed by a processor on the computer system they may gather or receive two or more quanta of data from the computer system or a second computer system. The instructions may automatically gather the two or more quanta of data by searching the computer system or a network. The data may be received from another computer, a network location, a physical medium (such as a hard drive, USB drive, DVD, CD-ROM etc.), and may be transmitted by a computer or a person, such as a system administrator.

In an embodiment, a separate computer system or program, or a system administrator or developer may transmit the two or more quanta of data to the program.

The program may gather the data by retrieving logs, system data, software program data, metadata, searching a network, or other methods.

In an embodiment, a system administrator may provide some or all of the data.

The data may include source code for one or more applications installed on the computer system or the second computer system. Source code may include the codebase for the application. The codebase may include scripts, libraries, runtimes, etc. Source code may be gathered for all services, including frontend and backend services.

The data may include documentation for the one or more applications. Documentation may include API documentation, architecture design, code comments, design documents, testing documents, and other documentation used to create the program originally or any previous updates.

The data may include one or more logs for one or more uses of the one or more applications. Logs may include error logs, performance metrics, and data metric metrics. Data metrics may include response times, memory usage, runtime behavior and similar metrics. Data metrics may also include data on some or all software installed on the computer system, including performance data, memory utilization, processor utilization, and process runtimes for the software analyzed.

The data may include one or more configuration files for the one or more applications. Configuration files may be unique to a particular computer or user. For example, every time a program is installed or updated on a computer system, a configuration file may be generated. The configuration file may include specifics on the hardware of that particular computer. The configuration file may include specifics on how a particular user has configured the program to run or display. In an embodiment, the particular user may be an entity.

Configuration files may include hardware data. Hardware data may include model of the computer system along with system specifications, such as RAM, CPU, storage size, storage remaining, and other hardware specifications. Hardware data may include performance, volume, and load capacity of each separate piece of hardware and the system as a whole.

The data may include one or more user inputs. User inputs may include every interaction with a program by a user. The user input data may be divided between users or may include data for all users that use the program on a particular computer system.

The data may include one or more issue reports. Issue reports may include day-to-day incidents, errors, support tickets, customer care queries and similar incident reports.

The data may include other data. Any data required by the analyzer program to analyze properly or more efficiently may be gathered or received.

The instructions may store the two or more quanta of data in a database. The database may be part of the computer system or separate from the computer system.

The database may be located at the computer system. The database may be located remotely from the computer system. The database may be located at or near the computer system with the computer program. The database may be located remotely from the computer system with the computer program. The database may be accessed over an internal or external network.

In an embodiment, the database may be distributed across multiple computer systems or servers. The distributed systems or servers may be geographically distant.

In an embodiment, the database may be encrypted. Encrypting the database may be required depending on the sensitivity of the network or computer systems. Any appropriate encryption protocol or method may be used.

The instructions may pre-process the two or more quanta of data. The pre-processing process may include analyzing the data with a one or more multi-modal artificial intelligence/machine learning (“AI/ML”) algorithms. Pre-processing outputs may include code parsing, text processing, log aggregation, and configuration files standardization.

Code parsing may include recognizing code structures, identifying dependencies, analyzing control flow, detecting patterns, and determining areas of code that may be re-factored or re-worked during an upgrade of the program.

Text processing may include extracting information from all of the documentation and user feedback to understand the functionality, usage patterns and issues with the existing software program.

Log aggregation may include cleaning all of the logs and highlighting/determining important logged events, errors, performance stability and performance issues. These highlighted data may inform the code-analyzer of which areas of the existing program may need to be addressed, and in what order.

Configuration files standardization may include standardizing the dataset of configuration files to determine inconsistencies between computing systems, environments, and software programs.

The instructions may store the pre-processed two or more quanta of data in the database or a different database.

The database may be located at the computer system. The database may be located remotely from the computer system. The database may be located at or near the computer system with the computer program. The database may be located remotely from the computer system with the computer program. The database may be accessed over an internal or external network.

In an embodiment, the database may be distributed across multiple computer systems or servers. The distributed systems or servers may be geographically distant.

In an embodiment, the database may be encrypted. Encrypting the database may be required depending on the sensitivity of the network or computer systems. Any appropriate encryption protocol or method may be used.

The instructions may analyze, with one or more multi-modal artificial intelligence/machine learning (“AI/ML”) algorithms, the processed two or more quanta of data. A multi-modal AI/ML algorithm may refer to an AI/ML algorithm that analyzes data from multiple sources and multiple types of sources, such as source code, textual, audiovisual, etc.

In an embodiment, the analysis may include creating a digital twin of the computer system to model changes to the program. A digital twin may be an exact, but virtual, copy of the computer system. A digital twin may be a virtual representation of computer system. For example, a digital twin may virtually model each of the 100 (or ‘n’) threads available in a particular CPU, along with free RAM, to determine how many threads would be used during an update of the older version. For example, if the computer system (i.e., all of the software already installed) is using 95/100 of the threads or processes in a CPU before any update, along with 3 out of the 4 gb of RAM available, the digital twin will reflect the used and available processes and memory available, along with all other monitored parameters (network bandwidth, storage available, etc.).

The analysis may include a code structure analysis, dependency mapping, performance and scalability analysis, and error and stability analysis.

Code structure analysis may include parsing the source code to understand relationships between various code elements or modules, as well as relationships between different applications.

Code structure analysis may also include identifying patterns, complex structures, coupled modules/components, and identifying which code is outdated, needs refactoring or modernization etc.

Dependency mapping may include generating a dependency graph or chart displaying the connections between code, external libraries, other modules, other applications, and other connections. Dependency mapping may include analyzing each dependency for various risks, including displaying a critical flow, an outdated connection, complex flow, etc.

The performance and scalability analysis may include processing the input logs to identify patterns in resource utilization, to determine where performance lags, is dropped, or runs well. This analysis may determine areas of code where excess computing resources (such as memory or processor cycles) are used, to identify areas of code for optimization.

The error and stability analysis may include analyzing error logs to identify code areas or modules that are most responsible for errors or system instability. The analysis may include generating a list of stability risks for each code module. Prioritization for updating may be applied according to the list of risks and error proneness. This may help identify areas of code which may need to be updated first to avoid or correct instabilities.

The instructions may calculate two or more metrics based on the analysis. For example, metrics or scores may run from 1 to 10, or 1 to 100 for a more granular view. Higher scores may indicate more complex issues, or higher risks. For example, a dependency risk score of 90 may indicate a high risk compared to a score of 10. Other scoring relations may be used. Other values may be used.

Table 1 below identifies various metrics, their purpose, how they are calculated and possibilities for what the metric may be used for.

TABLE 1

| Metric/score | Purpose | Calculation | Use |
|---|---|---|---|
| Code | To assess the | May use structural | Software with |
| complexity | complexity of | analysis such as | high complexity |
| | each module of | nesting levels, | scores may |
| | source code. | recursions, code | require more |
| | | patterns, obsolete | computing |
| | | code, etc. | resources, more |
| | | | testing, and |
| | | | more re- |
| | | | factoring in an |
| | | | upgrade. |
| Dependency | To assess risk | May use dependency | This metric may |
| risk | involved in | age, whether | help in |
| | updating code | dependency used | planning |
| | and code | frequently, whether | software |
| | dependencies. | dependency changed | upgrades and |
| | | for particular | migration in an |
| | | module frequently, | orderly manner |
| | | etc. Unknown | to reduce |
| | | dependencies may be | dependency |
| | | given higher scores | issues and |
| | | due to chance of | bugs. |
| | | integration issues | |
| Performance | To predict how | May analyze | A higher score |
| impact | a particular | historical resource | may be |
| | upgrade may | usage, performance | prioritized for |
| | impact system | bottlenecks, large | optimization |
| | performance. | volume processing | first to |
| | | and other resource | maximize the |
| | | usages. | return on |
| | | | invested |
| | | | development |
| | | | resources. |
| Error | To estimate, to | May analyze past | Modules or code |
| proneness | a particular | error logs to | with high |
| | level of | determine frequent | error-proneness |
| | confidence | issues. May be | scores may be |
| | (low, medium, | correlated with | prioritized to |
| | high, greater | code complexity | reduce the |
| | than 50% etc.) | score and user | number of bugs |
| | the possibility | reported issues. | and provide |
| | of errors in | | additional |
| | each code | | developer |
| | module after a | | resources to |
| | proposed | | resolve issues. |
| | upgrade. | | |
| Documentation | To assess the | May analyze all of | Modules with |
| quality | documentation | the documentation | low |
| | quality for | to determine | documentation |
| | each code | whether it is high | quality scores |
| | module. | quality or not. | may require |
| | | | additional |
| | | | details from |
| | | | developers. |
| User feedback | To assess the | May analyze the | May be used to |
| priority | user-reported | number of user | prioritize code |
| | issues related | complaints or | or modules that |
| | to a software | feedback for each | impact user |
| | program or | usage of the | satisfaction. |
| | particular | software program. | |
| | software | The more | |
| | module. | complaints, the | |
| | | higher the priority | |
| | | may be. May be | |
| | | compared to user | |
| | | expectations. | |

The instructions may automatically design, and prioritize tasks within, a strategic upgrade plan based on the two or more calculated metrics. A strategic upgrade plan may include one or more areas for a developer to focus resources as well as prioritizing tasks, such as upgrading tasks, development tasks, and migration tasks.

In an embodiment, a developer may include a person. In an embodiment, a developer may include a computer program that develops code, such as an AI/ML algorithm.

Table 2 below identifies various strategic upgrade plan components, which metrics may be used to determine the plan (s) components, a possible embodiment of what to do with various metrics, and possible results. A single strategic upgrade plan may include one or more of the components in Table 2, as well as other, non-listed components.

TABLE 2

| Strategic | | | |
|---|---|---|---|
| Upgrade Plan | | How the Plan | |
| Component | Metric (s) Used | May Work | Possible Result |
| Prioritization | Code | Start with low- | List of modules to |
| of modules to | complexity, | complexity and | upgrade in a |
| upgrade | error- | low error- | prioritized order, |
| | proneness | proneness code | balancing upgrades |
| | | modules, | with potential |
| | | followed by | risks. |
| | | medium, then | |
| | | high. | |
| Resource | Dependency | May indicate | May efficiently use |
| allocation | risk | how risky it | resources, focusing |
| | | may be to | on low and high- |
| | | upgrade a | risk dependencies. |
| | | module based on | |
| | | its | |
| | | dependencies. | |
| | | Allocate more | |
| | | resources for | |
| | | high-risk | |
| | | dependency | |
| | | scores and less | |
| | | resources for | |
| | | low-risk | |
| | | dependency | |
| | | scores. | |
| Document | Documentation | May help a | Improved |
| enhancement | | developer | documentation may |
| | | understand | help reduce errors, |
| | | current code | providing for |
| | | functionality | smoother upgrades |
| | | and | and migrations. |
| | | dependencies | |
| | | before | |
| | | upgrading. | |
| Addressing | User feedback | Identifying | May help improve |
| user needs | priority | modules or code | user experience and |
| | | functionalities | user feedback by |
| | | that have | prioritizing |
| | | direct impact | upgrading modules |
| | | on users. | that users request. |
| Managing risk | Error- | Identifying the | May reduce the risk |
| | proneness, | most | of post-upgrade or |
| | dependency | problematic | migration errors. |
| | risk | areas in the | |
| | | source code. | |

The instructions may automatically implement the strategic upgrade plan or plans.

The instructions may initiate an automatic performance monitoring system. The automatic performance monitoring system may monitor performance of the one or more applications before and after the strategic upgrade plan is implemented.

The automatic performance monitoring system may generate one or more performance reports. A performance report may be used for prioritization of issues, discovering user needs, and for product design.

In an embodiment, the computer system may be on a network. The network may be the Internet. The network may be external. The network may be an internal intranet.

In an embodiment, the executable instructions may further search the network for one or more additional computer systems where the one or more applications are installed on the one or more additional computer systems. For example, the computer system may be one of ten computers on an internal network. Six of those computers may have an older version of the software program installed. The instructions may search the available data on each additional computer system to determine if an older version is installed or not.

In an embodiment, the search may be continuous. In an embodiment, the search may occur at predetermined intervals (e.g., every hour, every day, every 10 days, etc.). The pre-determined intervals may be adjusted manually or automatically.

In an embodiment, when the one or more additional computer systems are discovered, the instructions may install a copy of the in-depth code analyzer computer program product on each additional computer system, creating an original code analyzer and one or more copied code analyzers.

The in-depth code analyzer program may only be installed on each additional computer system that includes an older version of the software program that is being updated. This may create an original code analyzer and one or more copied code analyzers.

In an embodiment, when the instructions install the one or more copied code analyzers, each copy may record two or more quanta of data in the database.

In an embodiment, the original code analyzer may analyze all data in the database.

In an embodiment, when the instructions install the one or more copied code analyzers, each copy may record two or more quanta of data in the same database available to the original code analyzer. The two or more quanta of data may be the same type(s) of data recorded by the original code analyzer. Recording all of the data in the same database may allow for more robust analysis as well as creation of code and designing of more efficient upgrade plans.

In an embodiment, the original code analyzer may analyze all data in the database. In this embodiment, one code analyzer, either the original or a copy, may perform the required analysis. Having only one code analyzer perform the analysis (and other steps) may increase efficiency and reduce redundancies. The group of code analyzers may automatically determine which code analyzer should perform the analysis. The group may assign the analysis to the code analyzer on the most powerful computer system. Alternatively, the analysis may always be performed by the original code analyzer.

In an embodiment, the analysis (and other steps) may be performed by all computer systems that include a code analyzer. The analysis may be distributed amongst part or all of the computer systems. Performing distributed calculation may increase efficiency and the computing resources available to perform calculations, as no single computer systems may be as powerful as a group of distributed computer systems.

In an embodiment, the calculated two or more metrics may include one or more of: a code complexity score; a dependency risk score; a performance impact score; an error proneness score; a documentation quality score; a user feedback priority score; and other metrics.

Each metric may be analyzed on a scale. The scale may be of any type. For example, the scale may be a number from 0 through 10, with 10 being highest risk or most complex and 0 being lowest risk, o 0 to 100 for a more granular scoring system. The scale may be adjusted dynamically by the program. The scale may be adjusted manually by an administrator or developer.

In an embodiment, the strategic upgrade plan may include one or more of: a prioritization of one or more software modules to upgrade; a resource allocation plan; documentation enhancement; addressing one or more needs of a user; managing one or more elements of risk; and other plans.

In an embodiment, the prioritization of one or more software modules to upgrade may utilize the code complexity score and the error proneness score, as well as other metrics.

In an embodiment, the resource allocation plan may utilize the dependency risk score, as well as other metrics.

In an embodiment, the documentation enhancement may utilize the documentation score, as well as other metrics.

In an embodiment, addressing one or more needs of a user may utilize the user feedback priority score as well as other metrics.

In an embodiment, managing risk may utilize the error proneness score and the dependency risk score, as well as other metrics.

In an embodiment, the instructions may implement the strategic upgrade plan using machine-readable code.

The instructions may automatically generate machine-readable code to implement the strategic upgrade plan. The machine-readable code may be in any programming language. The machine-readable code may be a script. The machine-readable code may be a more involved executable program. For example, the machine-readable code may be a script that, (in pseudo-code) does the following:

```
Start
  Cancel program “a”;
  Cancel program “b”;
  Cancel program “c”;
  Pause program “d”;
  Pause program “e”;
  Install updated version;
  Restart program “a”;
  Restart program “b”;
  Restart program “c”;
  Continue program “d”;
  Continue program “e”;
End
```

The instructions may test the strategic upgrade plan and the machine-readable code on a digital twin and revise the upgrade plan and machine-readable code based on the test. For example, if the proposed upgrade plan proposes closing five applications to free up X processes and Y memory, the instructions may test to determine if closing those five applications will free up X processes and Y memory, or a different number. The instructions may also test if closing those applications or other proposed actions will disrupt the computer system or network, and how long it may take to install. The instructions may also test if the generated code performs as expected.

In an embodiment, the instructions may automatically search a network, such as the Internet, for an updated version of the software program. The search may be constant. The search may be at predetermined intervals, such as every week or every 30 days.

In an embodiment, the strategic upgrade plan or plans may be formulated to minimize downtime and disruption for: the computer system, the network, and the one or more additional computer systems. For example, if 10 computer systems on a network of 20 computer systems need to have software upgraded from the original version to an updated version, the upgrade plan may be designed to minimize downtime and disruption for the network as a whole, all 20 computers on the network, as well as the ten computers with the software. For example, the ten computers may need to be restarted, but doing so may prevent those ten computers from performing other functions for the network. The proposed upgrade plan may decide to stagger the restarts, so only one of the twenty computers is down and unavailable at any one time.

In an embodiment, the analysis may use one or more multi-modal artificial intelligence/machine learning (“AI/ML”) algorithms. Any suitable multi-modal AI/ML algorithms may be used. Each algorithm may dynamically evaluate one or more factors in its analysis. The algorithm(s) may iterate. The algorithm(s) may be trained on a training set of data. The training set may be created data or actual data. The algorithms may be checked by one or more system administrators.

An apparatus for an in-depth code analyzer is provided. The apparatus may include a central server and one or more network nodes.

The central server may include a server communication link, a server processor, and a server non-transitory memory configured to store at least a server operating system and a server in-depth code analyzer.

Each of the one or more network nodes may include a node communication link, a node processor, and a node non-transitory memory configured to store at least a node operating system and an older version of a software program.

When the server in-depth code analyzer receives instructions to develop an updated version of the software program, the server in-depth code analyzer program may collect from each of the one or more network nodes, two or more quanta of data.

The data may include source code for the software program, documentation for the software program, one or more logs for one or more uses of the software program, one or more configuration files for the older version of the program, one or more user inputs, one or more issue reports, as well as other data.

The in-depth code analyzer may pre-process the two or more quanta of data.

The in-depth code analyzer may analyze, with one or more multi-modal artificial intelligence/machine learning algorithms, the processed two or more quanta of data.

The in-depth code analyzer may calculate two or more metrics based on the analysis.

As part of a strategic upgrade plan, the in-depth code analyzer may automatically design and prioritize one or more of: an upgrade task for the software program, a development task for the software program, and a migration task for the software program.

In an embodiment, an entity may migrate from one computer program to another, or from one platform to another (such as local to the cloud). The in-depth code analyzer may analyze code similarly for migration of programs as for updating a program.

In some embodiments, the strategic upgrade plan may include one of each. In other embodiments, the strategic upgrade plan may omit one or more of the upgrade tasks, development tasks, and migration tasks.

In an embodiment, the in-depth code analyzer may automatically implement the one or more of the upgrade task, the development task, and the migration task according to the prioritization. In other embodiments, the in-depth code analyzer may request permission from a system administrator or developer before implementing any task.

In an embodiment, the in-depth code analyzer may initiate an automatic performance monitoring system. The automatic performance monitoring system may monitor performance of the software program on one or more nodes before or after the upgrade task, the development task, and the migration task are implemented.

In an embodiment, the in-depth code analyzer may revise one or more of the upgrade task, the development task, and the migration task based on the performance.

In an embodiment, the in-depth code analyzer may revise one or more of the upgrade task, the development task, and the migration task to a pre-determined condition.

In an embodiment, the in-depth code analyzer may automatically update the older version of the software program to an updated version on each of the one or more nodes that includes an older version of the software program.

A method for in-depth analysis of a software program using one or more multi-modal artificial intelligence/machine learning algorithms is provided.

The method may include the step of collecting, from one or more computer systems, two or more quanta of data. The data may include source code for the software program, documentation for the software program, one or more logs for one or more uses of the software program, one or more configuration files for the one or more applications, one or more user inputs, one or more issue reports, as well as other data.

The method may include the step of storing the two or more quanta of data in a database.

The method may include the step of pre-processing the two or more quanta of data.

The method may include the step of storing the pre-processed two or more quanta of data in the database.

The method may include the step of analyzing, with the one or more multi-modal artificial intelligence/machine learning algorithms, the processed two or more quanta of data.

The method may include the step of calculating two or more metrics based on the analysis.

The method may include the step of, as part of a strategic upgrade plan, automatically designing and prioritizing one or more of: an upgrade task for the software program; a development task for the software program; and a migration task for the software program.

The method may include the step of automatically implementing the upgrade task, the development task, and the migration task.

The method may include the step of initiating an automatic performance monitoring system. The automatic performance monitoring system may monitor performance of the software program after the upgrade task, the development task, and the migration task are implemented.

One of ordinary skill in the art will appreciate that the steps shown and described herein may be performed in other than the recited order and that one or more steps illustrated may be optional. Apparatus and methods may involve the use of any suitable combination of elements, components, method steps, computer-executable instructions, or computer-readable data structures disclosed herein.

Illustrative embodiments of apparatus and methods in accordance with the principles of the invention will now be described with reference to the accompanying drawings, which form a part hereof. It is to be understood that other embodiments may be utilized, and that structural, functional, and procedural modifications may be made without departing from the scope and spirit of the present invention.

As will be appreciated by one of skill in the art, the invention described herein may be embodied in whole or in part as a method, a data processing system, or a computer program product. Accordingly, the invention may take the form of an entirely hardware embodiment, or an embodiment combining software, hardware and any other suitable approach or apparatus.

Furthermore, such aspects may take the form of a computer program product stored by one or more computer-readable storage media having computer-readable program code, or instructions, embodied in or on the storage media. Any suitable computer readable storage media may be utilized, including hard disks, CD-ROMs, optical storage devices, magnetic storage devices, and/or any combination thereof. In addition, various signals representing data or events as described herein may be transferred between a source and a destination in the form of electromagnetic waves traveling through signal-conducting media such as metal wires, optical fibers, and/or wireless transmission media (e.g., air and/or space).

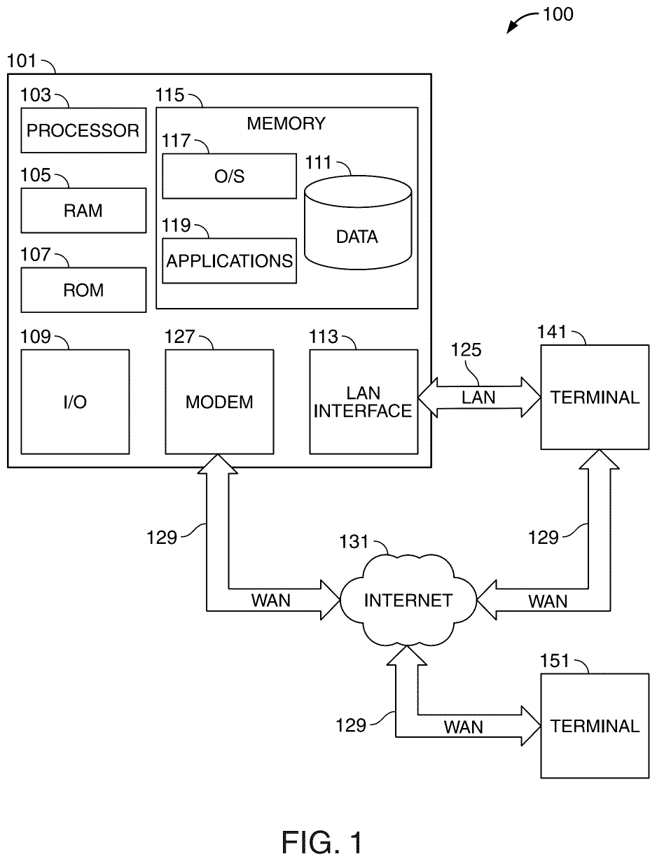

In accordance with principles of the disclosure, FIG. 1 shows an illustrative block diagram of apparatus 100 that includes a computer 101. Computer 101 may alternatively be referred to herein as a “computing device.” Elements of apparatus 100, including computer 101, may be used to implement various aspects of the apparatus and methods disclosed herein. A “user” of apparatus 100 or computer 101 may include other computer systems or servers or computing devices, such as the program described herein.

Computer 101 may have one or more processors/microprocessors 103 for controlling the operation of the device and its associated components, and may include RAM 105, ROM 107, input/output module 109, and a memory 115. The microprocessors 103 may also execute all software running on the computer 101—e.g., the operating system 117 and applications 119 such as an in-depth code analyzer and security protocols. Other components commonly used for computers, such as EEPROM or Flash memory or any other suitable components, may also be part of the computer 101.

The memory 115 may be comprised of any suitable permanent storage technology—e.g., a hard drive or other non-transitory memory. The ROM 107 and RAM 105 may be included as all or part of memory 115. The memory 115 may store software including the operating system 117 and application(s) 119 (such as an in-depth code analyzer and security protocols) along with any other data 111 (e.g., historical data, configuration file) needed for the operation of the apparatus 100. Memory 115 may also store applications and data. Alternatively, some or all of computer executable instructions (alternatively referred to as “code”) may be embodied in hardware or firmware (not shown). The microprocessor 103 may execute the instructions embodied by the software and code to perform various functions.

The network connections/communication link may include a local area network (LAN) and a wide area network (WAN or the Internet) and may also include other types of networks. When used in a WAN networking environment, the apparatus may include a modem or other means for establishing communications over the WAN or LAN. The modem and/or a LAN interface may connect to a network via an antenna. The antenna may be configured to operate over Bluetooth, wi-fi, cellular networks, or other suitable frequencies.

Any memory may be comprised of any suitable permanent storage technology—e.g., a hard drive or other non-transitory memory. The memory may store software including an operating system and any application(s) (such as an in-depth code analyzer and security protocols) along with any data needed for the operation of the apparatus and to allow bot monitoring and IoT device notification. The data may also be stored in cache memory, or any other suitable memory.

An input/output (“I/O”) module 109 may include connectivity to a button and a display. The input/output module may also include one or more speakers for providing audio output and a video display device, such as an LED screen and/or touchscreen, for providing textual, audio, audiovisual, and/or graphical output.

In an embodiment of the computer 101, the microprocessor 103 may execute the instructions in all or some of the operating system 117, any applications 119 in the memory 115, any other code necessary to perform the functions in this disclosure, and any other code embodied in hardware or firmware (not shown).

In an embodiment, apparatus 100 may consist of multiple computers 101, along with other devices. A computer 101 may be a mobile computing device such as a smartphone or tablet.

Apparatus 100 may be connected to other systems, computers, servers, devices, and/or the Internet 131 via a local area network (LAN) interface 113.

Apparatus 100 may operate in a networked environment supporting connections to one or more remote computers and servers, such as terminals 141 and 151, including, in general, the Internet and “cloud”. References to the “cloud” in this disclosure generally refer to the Internet, which is a world-wide network. “Cloud-based applications” generally refer to applications located on a server remote from a user, wherein some or all of the application data, logic, and instructions are located on the internet and are not located on a user's local device. Cloud-based applications may be accessed via any type of internet connection (e.g., cellular or wi-fi).

Terminals 141 and 151 may be personal computers, smart mobile devices, smartphones, IoT devices, or servers that include many or all of the elements described above relative to apparatus 100. The network connections depicted in FIG. 1 include a local area network (LAN) 125 and a wide area network (WAN) 129 but may also include other networks. Computer 101 may include a network interface controller (not shown), which may include a modem 127 and LAN interface or adapter 113, as well as other components and adapters (not shown). When used in a LAN networking environment, computer 101 is connected to LAN 125 through a LAN interface or adapter 113. When used in a WAN networking environment, computer 101 may include a modem 127 or other means for establishing communications over WAN 129, such as Internet 131. The modem 127 and/or LAN interface 113 may connect to a network via an antenna (not shown). The antenna may be configured to operate over Bluetooth, wi-fi, cellular networks, or other suitable frequencies.

It will be appreciated that the network connections shown are illustrative and other means of establishing a communications link between computers may be used. The existence of various well-known protocols such as TCP/IP, Ethernet, FTP, HTTP, and the like is presumed, and the system can be operated in a client-server configuration. The computer may transmit data to any other suitable computer system. The computer may also send computer-readable instructions, together with the data, to any suitable computer system. The computer-readable instructions may be to store the data in cache memory, the hard drive, secondary memory, or any other suitable memory.

Application program(s) 119 (which may be alternatively referred to herein as “plugins,” “applications,” or “apps”) may include computer executable instructions for an in-depth code analyzer and security protocols, as well as other programs. In an embodiment, one or more programs, or aspects of a program, may use one or more AI/ML algorithm(s). The various tasks may be related to gathering data and analyzing code in preparation for updating, upgrading, or migrating a software program.

Computer 101 may also include various other components, such as a battery (not shown), speaker (not shown), a network interface controller (not shown), and/or antennas (not shown).

Terminal 151 and/or terminal 141 may be portable devices such as a laptop, cell phone, tablet, smartphone, server, or any other suitable device for receiving, storing, transmitting and/or displaying relevant information. Terminal 151 and/or terminal 141 may be other devices such as remote computers or servers. The terminals 151 and/or 141 may be computers where a user is interacting with an application.

Any information described above in connection with data 111, and any other suitable information, may be stored in memory 115. One or more of applications 119 may include one or more algorithms that may be used to implement features of the disclosure, and/or any other suitable tasks.

In various embodiments, the invention may be operational with numerous other general purpose or special purpose computing system environments or configurations. Examples of well-known computing systems, environments, and/or configurations that may be suitable for use with the invention in certain embodiments include, but are not limited to, personal computers, servers, hand-held or laptop devices, tablets, mobile phones, smart phones, other Computers, and/or other personal digital assistants (“PDAs”), multiprocessor systems, microprocessor-based systems, set top boxes, programmable consumer electronics, network PCs, minicomputers, mainframe computers, distributed computing environments that include any of the above systems or devices, IoT devices, and the like.

Aspects of the invention may be described in the general context of computer-executable instructions, such as program modules, being executed by a computer. Generally, program modules include routines, programs, objects, components, data structures, etc., that perform particular tasks or implement particular abstract data types. The invention may also be practiced in distributed computing environments where tasks are performed by remote processing devices that are linked through a communications network, e.g., cloud-based applications. In a distributed computing environment, program modules may be located in both local and remote computer storage media including memory storage devices.

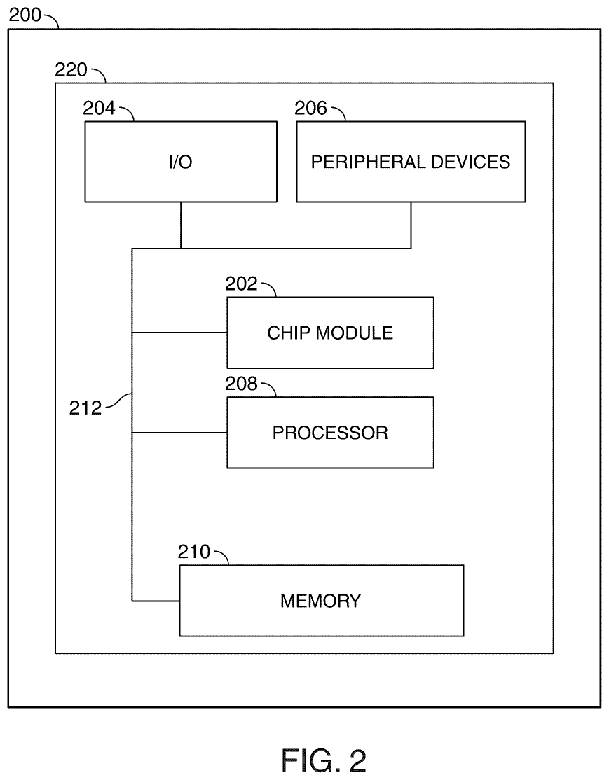

FIG. 2 shows illustrative apparatus 200 that may be configured in accordance with the principles of the disclosure. Apparatus 200 may be a server or computer with various peripheral devices 206. Apparatus 200 may include one or more features of the apparatus shown in FIGS. 1-6. Apparatus 200 may include chip module 202, which may include one or more integrated circuits, and which may include logic configured to perform any other suitable logical operations.

Apparatus 200 may include one or more of the following components: I/O circuitry 204, which may include a transmitter device and a receiver device and may interface with fiber optic cable, coaxial cable, telephone lines, wireless devices, PHY layer hardware, a keypad/display control device, an display (LCD, LED, OLED, etc.), a touchscreen or any other suitable media or devices; peripheral devices 206, which may include other computers; logical processing device 208, which may compute data information and structural parameters of various applications; and machine-readable memory 210.

Machine-readable memory 210 may be configured to store in machine-readable data structures: machine executable instructions (which may be alternatively referred to herein as “computer instructions” or “computer code”), applications, signals, recorded data, and/or any other suitable information or data structures. The instructions and data may be encrypted.

Components 202, 204, 206, 208 and 210 may be coupled together by a system bus or other interconnections 212 and may be present on one or more circuit boards such as 220. In some embodiments, the components may be integrated into a single chip. The chip may be silicon-based.

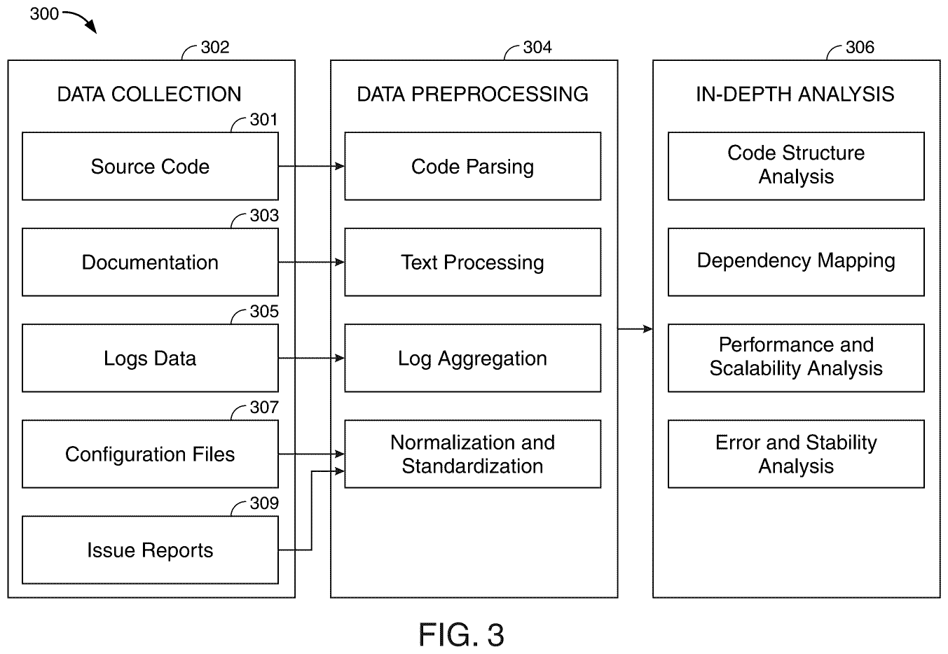

FIG. 3 shows an illustrative schematic in accordance with principles of the disclosure. Apparatus may include any of the components and systems odd-numbered 301 through 309, among other components, as well as steps labeled on FIG. 3. Steps may be performed on the apparatus shown in FIGS. 1-4, and 6 or other apparatus shown in other figures or described elsewhere

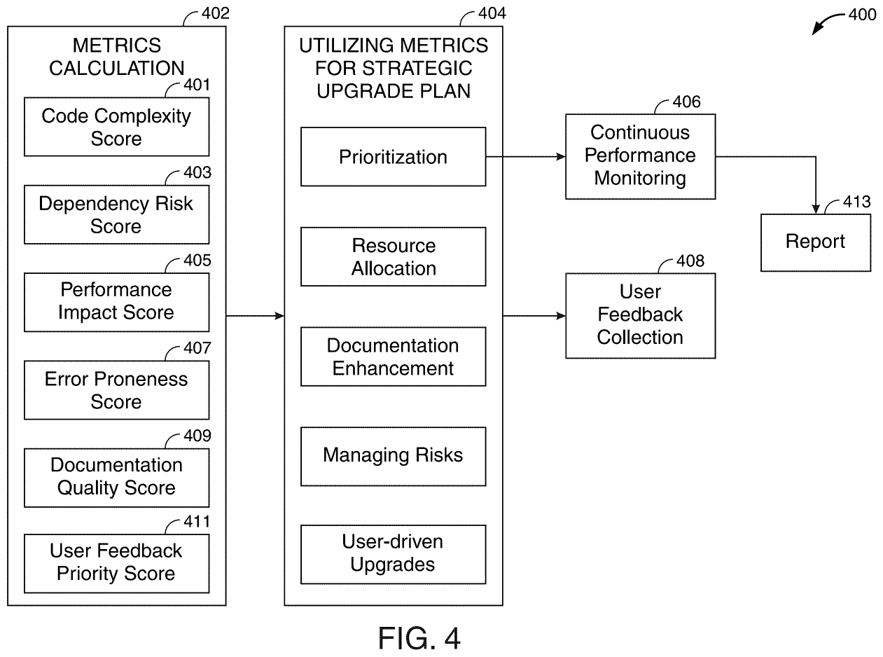

An in-depth code analyzer program 300 may perform the steps of data collection 302, data preprocessing 304, and in-depth analysis 306. Additional steps may also be performed, such as those shown on FIG. 4.

Data collection at step 302 may include gathering or receiving source code 301, documentation 303, data logs 305, configuration files 307, issue reports 309, and other data.

The data 301-309 collected at step 302 may be pre-processed at step 304. The pre-processing at step 304 may include code parsing, text processing, log aggregation, and file/report normalization and standardization.

The data pre-processed at step 304 may be analyzed in-depth at step 306. In-depth analysis 306 may include code structure analysis, dependency mapping, performance and scalability analysis, error and stability analysis and other analysis.

FIG. 4 shows an illustrative schematic in accordance with principles of the disclosure. Apparatus may include any of the components and systems odd-numbered 401 through 413, among other components, as well as steps labeled on FIG. 4 as 402-408. Steps may be performed on the apparatus shown in FIGS. 1-4, and 6 or other apparatus shown in other figures or described elsewhere.

An in-depth code analysis program 400 may perform the steps of metrics calculation 402, creating a strategic upgrade plan 404, implementing the plan, continuous performance monitoring at step 406, and user feedback collection at step 408, among other steps, including those steps shown in FIG. 3. In an embodiment, the steps in FIG. 4 may be performed after the steps in FIG. 3.

The metrics/score calculation at step 402 may include a code complexity score 401, a dependency risk score 403, a performance impact score 405, an error proneness score 407, a documentation score 409, a user feedback priority score 409, as well as other metrics.

The strategic upgrade plan at step 404 may include prioritization, resource allocation, documentation enhancement, managing risks, and user-driven or requested upgrades.

The continuous or intermittent performance monitoring at step 406 may include generating one or more reports 413.

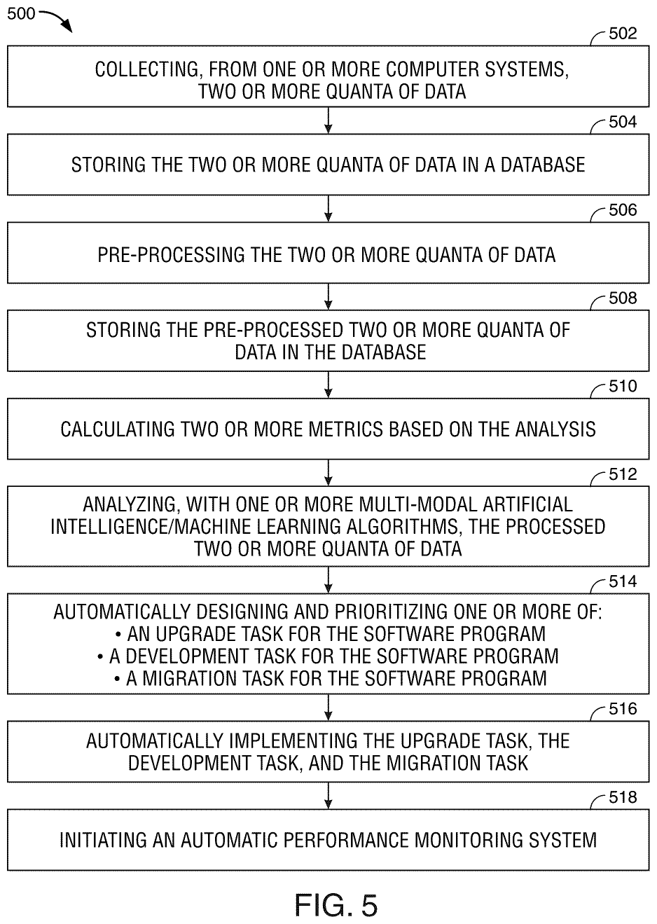

FIG. 5 shows an illustrative flowchart in accordance with principles of the disclosure. Methods may include some or all of the method steps numbered 502 through 518. Methods may include the steps illustrated in FIG. 5 in an order different from the illustrated order. The illustrative method shown in FIG. 5 may include one or more steps performed in other figures or described herein. Steps 502 through 518 may be performed on the apparatus shown in FIGS. 1-4, 6 or other apparatus.

At step 502, an in-depth code analyzer program on a server (centralized or decentralized) may collect, from one or more computer systems, two or more quanta of data. The data may include, among other data, source code for the software program, documentation for the software program, one or more logs for one or more uses of the software program, one or more configuration files for the one or more applications, one or more user inputs, and one or more issue reports.

At step 504, the program may store the two or more quanta of data in a database.

At step 506 the program may pre-process the two or more quanta of data.

At step 508, the program may store the pre-processed two or more quanta of data in the database.

At step 510, the program may analyze, with one or more multi-modal artificial intelligence/machine learning algorithms, the processed two or more quanta of data.

At step 512, the program may calculate two or more metrics based on the analysis.

At step 514, the program may automatically design and prioritize one or more of: an upgrade task for the software program; a development task for the software program; and a migration task for the software program.

At step 516, the program may automatically implement the upgrade task, the development task, and the migration task.

At step 518, the program may initiate an automatic performance monitoring system. The automatic performance monitoring system may monitor performance of the software program after the upgrade task, the development task, and the migration task are implemented.

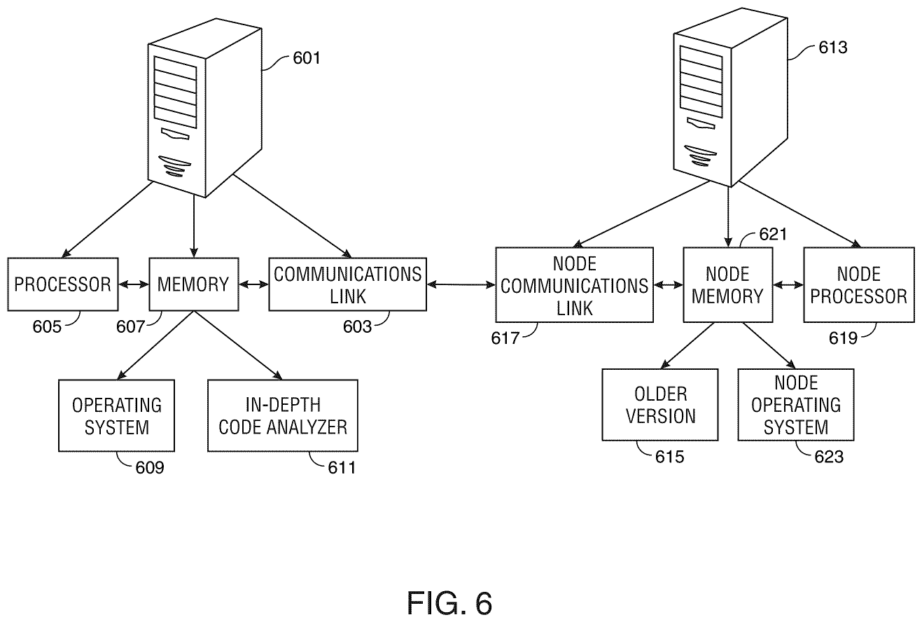

FIG. 6 shows an illustrative apparatus in accordance with principles of the disclosure. The apparatus may include a central server 601 and one or more network nodes 613.

The central server 601 may include a server communications link 603, a server processor/processors 605, and a server non-transitory memory 607, as well as other components.

Network node 613 613 may include a node communications link 617, a node processor or processors 619, and a node non-transitory memory 621.

The server non-transitory memory 607 may include a server operating system 609, an in-depth code analyzer application 611, as well as other data and programs.

The server communications link 603 may communicate with each node 613 (as well as other servers/computers, not shown). The in-depth code analyzer 611 may communicate with all nodes 613 through the server communications link 603.

The node non-transitory memory 621 may include a node operating system 623, and an older version of a software program 615.

When the server in-depth code analyzer 611 receives instructions to develop an updated version of the software program 615, the server in-depth code analyzer program 611 may collect from each of the one or more network nodes 613, two or more quanta of data. The data may include, among other data, source code for the software program, documentation for the software program, one or more logs for one or more uses of the software program, one or more configuration files for the one or more applications, one or more user inputs, and one or more issue reports.

The analyzer 611 may then pre-process the two or more quanta of data.

The analyzer 611 may analyze, with one or more multi-modal artificial intelligence/machine learning algorithms, the processed two or more quanta of data.

The analyzer 611 may calculate two or more metrics based on the analysis.

The analyzer 611 may automatically design and prioritize one or more of: an upgrade task for the software program, a development task for the software program, and/or a migration task for the software program.

Thus, apparatus and methods for an in-depth code analyzer using multi-modal artificial intelligence/machine learning are provided. Persons skilled in the art will appreciate that the present invention can be practiced by other than the described embodiments, which are presented for purposes of illustration rather than of limitation.

What is claimed is:

1. An in-depth code analyzer computer program product, the computer program product comprising executable instructions, the executable instructions when executed by a processor on a computer system:
gather two or more quanta of data from the computer system or a second computer system, wherein the data comprises:
source code for one or more applications installed on the computer system;
documentation for the one or more applications;
one or more logs for one or more uses of the one or more applications;
one or more configuration files for the one or more applications;
one or more user inputs; and
one or more issue reports;
store the two or more quanta of data in a database;
pre-process the two or more quanta of data;
store the pre-processed two or more quanta of data in the database;
analyze, with a multi-modal artificial intelligence/machine learning algorithm, the processed two or more quanta of data;
calculate two or more metrics based on the analysis;
automatically design and prioritize a strategic upgrade plan;
automatically implement the strategic upgrade plan; and
initiate an automatic performance monitoring system; wherein the automatic performance monitoring system monitors performance of the one or more applications.

2. The in-depth code analyzer computer program product of claim 1 wherein the computer system is on a network.

3. The in-depth code analyzer computer program product of claim 2 wherein the executable instructions further search the network for one or more additional computer systems where the one or more applications are installed on the additional computer systems.

4. The in-depth code analyzer computer program product of claim 3 wherein when the one or more additional computer systems are discovered, the instructions install a copy of the in-depth code analyzer computer program product on each additional computer system, creating an original code analyzer and one or more copied code analyzers.

5. The in-depth code analyzer computer program product of claim 4 wherein when the instructions install the one or more copied code analyzers, each copy records two or more quanta of data in the database.

6. The in-depth code analyzer computer program product of claim 5 wherein the original code analyzer analyzes all data in the database.

7. The in-depth code analyzer computer program product of claim 1 wherein the calculated two or more metrics comprise one or more of:
a) a code complexity score;
b) a dependency risk score;
c) a performance impact score;
d) an error proneness score;
e) a documentation quality score; and
f) a user feedback priority score.

8. The in-depth code analyzer computer program product of claim 7 wherein the strategic upgrade plan comprises one or more of:
a) a prioritization of one or more software modules to upgrade;
b) a resource allocation plan;
c) documentation enhancement;
d) addressing one or more needs of a user; and
e) managing one or more elements of risk.

9. The in-depth code analyzer computer program product of claim 8 wherein the prioritization utilizes the code complexity score and the error proneness score.

10. The in-depth code analyzer computer program product of claim 8 wherein the resource allocation plan utilizes the dependency risk score.

11. The in-depth code analyzer computer program product of claim 8 wherein:
the documentation enhancement utilizes the documentation score;
addressing one or more needs of a user utilizes the user feedback priority score; and
managing risk utilizes the error proneness score and the dependency risk score.

12. The in-depth code analyzer computer program product of claim 1 wherein the instructions implement the strategic upgrade plan using machine-readable code.

13. An apparatus for an in-depth code analyzer, the apparatus comprising:
a central server, the central server including:
a server communication link;
a server processor; and
a server non-transitory memory configured to store at least:
a server operating system; and
a server in-depth code analyzer program; and
one or more network nodes, each network node comprising:
a node communication link;
a node processor; and
a node non-transitory memory configured to store at least:
a node operating system; and
an older version of a software program; wherein when the server in-depth code analyzer receives instructions to develop an updated version of the software program, the server in-depth code analyzer program:
collects, from each of the one or more network nodes, two or more quanta of data, wherein the data comprises:
source code for the software program;
documentation for the software program;
one or more logs for one or more uses of the software program;
one or more configuration files for the older version;
one or more user inputs; and
one or more issue reports;
pre-processes the two or more quanta of data;
analyzes, with one or more multi-modal artificial intelligence/machine learning algorithms, the processed two or more quanta of data;
calculates two or more metrics based on the analysis; and
automatically designs and prioritizes one or more of:
an upgrade task for the software program;
a development task for the software program; and
a migration task for the software program.

14. The apparatus of claim 13 wherein the in-depth code analyzer automatically implements the upgrade task, the development task, and the migration task according to the prioritization.

15. The apparatus of claim 14 wherein the in-depth code analyzer initiates an automatic performance monitoring system.

16. The apparatus of claim 15 wherein the automatic performance monitoring system monitors performance of the software program after the upgrade task, the development task, and the migration task are implemented.

17. The apparatus of claim 16 wherein the in-depth code analyzer revises one or more of the upgrade task, the development task, and the migration task based on the performance.

18. The apparatus of claim 13 wherein the in-depth code analyzer revises one or more of the upgrade task, the development task, and the migration task to a pre-determined condition.

19. The apparatus of claim 13 wherein the in-depth code analyzer automatically updates the older version of the software program to an updated version on each of the one or more nodes.

20. A method for in-depth analysis of a software program using one or more multi-modal artificial intelligence/machine learning algorithms, the method comprising the steps of:
collecting, from one or more computer systems, two or more quanta of data, wherein the data comprises:
source code for the software program;
documentation for the software program;
one or more logs for one or more uses of the software program;
one or more configuration files for the software program;
one or more user inputs; and
one or more issue reports;
storing the two or more quanta of data in a database;
pre-processing the two or more quanta of data;
storing the pre-processed two or more quanta of data in the database;
analyzing, with the one or more multi-modal artificial intelligence/machine learning algorithms, the processed two or more quanta of data;
calculating two or more metrics based on the analysis;
automatically designing and prioritizing one or more of:
an upgrade task for the software program;
a development task for the software program; and
a migration task for the software program;
automatically implementing the upgrade task, the development task, and the migration task; and
initiating an automatic performance monitoring system; wherein the automatic performance monitoring system monitors performance of the software program after the upgrade task, the development task, and the migration task are implemented.
